(19) United States
(12) Patent Application Publication
(10) Pub. No.: US 2017/0238725 A1
(43) Pub. Date: Aug. 24, 2017

(54) HOLDER OPTIMIZED FOR VIEWING AND BROWSING DISPLAY CONTENT, A DIVIDER, AND METHODS OF MANUFATURING SAID HOLDER

(71) Applicant: BAD HAIR LLC, CHICAGO, IL (US)

(72) Inventor: BENJAMIN ROBERTSON, CHICAGO, IL (US)

(21) Appl. No.: 15/589,395

(22) Filed: May 8, 2017

Related U.S. Application Data
(63) Continuation-in-part of application No. PCT/US17/15522, filed on Jan. 28, 2017.
(60) Provisional application No. 62/289,163, filed on Jan. 29, 2016.

(51) Int. Cl. A47F 5/00; G09F 23/00; G06K 19/06; G09F 3/00; G09F 5/02; A47F 1/12

(52) U.S. Cl. CPC A47F 5/005; G09F 5/02; A47F 1/12; G06K 19/06037; G09F 3/0297; G09F 23/00

(57) ABSTRACT

A holder for display content is described. The display holder includes a main section, a first side panel, and a second side panel. The main section provides a base, a back panel, and a front panel. The back panel protrudes from a back edge of the base. The front panel protrudes from a front edge of the. The first side panel is attached to a first edge of the main section and the second side panel is attached to a second edge of the main section. The main section, the first side panel, and the second side panel define a recess for receiving the display content. A plurality of dividers are provided that securely fit the width of the main section receiving the display content.

### TECHNICAL FIELD

The present invention relates to a holder. More specifically, the invention relates to a display holder for content such as vinyl records in screen covers, a divider for easy access to display content in the holder, and methods of manufacturing said holder. The holder allows for viewing and browsing of the content and can be used for personal or commercial purposes. The divider allows for easy location, identification and manipulation of display content in the holder.

### SUMMARY

Holders for vinyl records, compact discs, comic books, collectible cards, brochures, and other content are commonly displayed in stores, personal homes, and the like. These holders, however, focus on prominently displaying (e.g., for viewing and browsing) on the top held material. Therefore, a holder is needed that allows a person to easily view and browse all the held materials. Also, the surface area occupied by the holder should be minimized in order to increase the amount of holders that can be placed on a surface while also maximizing ease of browsing and viewing materials held therein.

The present invention relates to a holder for display content. The holder includes a main section, a first side panel, and a second side panel. The main section provides a base, a back panel, and a front panel. The back panel protrudes from a back edge of the base. The front panel protrudes from a front edge of the base. The first side panel is attached to a first edge of the main section and the second side panel is attached to a second edge of the main section. The main section, the first side panel, and the second side panel define a recess for receiving the display content.

The present invention further relates to provides for a method of manufacturing the holder. A shape of the holder, including a main section, a first side panel, and a second side panel, is cut from a sheet metal, wherein the main section includes a base, a back panel, and a front panel. The back panel is folded towards the base along a back edge of the base, and the front panel is folded towards the base along a front edge of the base. The first side panel is folded along a first edge towards the main section, and attached to the main panel along the first edge. The second side panel is folded along a second edge towards the main section, and attached to the main panel along the second edge.

The present invention even further relates to a holder wherein the holder is composed of at least one of plastic, metal, wire mesh, or wood, or a combination of the same. In other embodiments, a kickstand is attached to the back panel and positioned to support the holder. In yet other embodiments, the first side panel and the second side panel are separable from the main section.

The present invention furthermore relates to a holder having a plurality of dividers for identifying, manipulating and separating display content in the holder.

Other advantages and features of the disclosure will become apparent upon review of the detailed description and accompanying drawings.

### BRIEF DESCRIPTION OF THE DRAWINGS

FIGS. 1A through 1D illustrate perspective views of a display holder, in accordance with the principles of the present invention;

FIG. 2 illustrates a side view of the display holder, in accordance with the principles of the present invention;

FIG. 3 illustrates an assembly view of the display holder, in accordance with the principles of the present invention;

FIGS. 4A and 4B illustrates perspective views of the display holder, in accordance with the principles of the present invention;

FIGS. 5A and 5B illustrate an assembly view of the display holder, in accordance with the principles of the present invention;

FIGS. 6A and 6B illustrate various views of a kickstand of the display holder, in accordance with the principles of the present invention;

FIG. 6C illustrates a perspective view of a display holder, in accordance with the principles of the present invention;

FIG. 6D illustrates a perspective view of a display holder, in accordance with the principles of the present invention;

FIGS. 7A and 7B illustrate various views of the kickstand of the display holder, in accordance with the principles of the present invention;

FIG. 8 illustrates an exploded view of the display holder, in accordance with the principles of the present invention;

FIGS. 9A and 9B illustrate various views of the display holder, in accordance with the principles of the present invention;

FIG. 10 illustrates a perspective view of the display holder, in accordance with the principles of the present invention;

FIG. 10A illustrates a side elevational view of the display holder, in accordance with the principles of the present invention;

FIG. 11 illustrates a front perspective view of a divider of the holder which can be used with a display holder, in accordance with the principles of the present invention

FIG. 11A illustrates a front perspective view of another embodiment of a divider of the holder which can be used with a display holder, in accordance with the principles of the present invention;

FIG. 11B illustrates a front perspective view of another embodiment of a divider of the holder which can be used with a display holder, in accordance with the principles of the present invention; and

FIG. 12 illustrates a front perspective view of yet another embodiment of a divider of the holder which can be used with a display holder, in accordance with the principles of the present invention.

### DETAILED DESCRIPTION

The following detailed embodiments presented herein are for illustrative purposes. That is, these detailed embodiments are intended to be exemplary of the present invention for the purposes of providing and aiding a person skilled in the pertinent art to readily understand how to make and use of the present invention.

Accordingly, the detailed discussion herein of one or more embodiments is not intended, nor is to be construed, to limit the metes and bounds of the patent protection afforded the present invention, in which the scope of patent protection is intended to be defined by the claims and equivalents thereof. Therefore, embodiments not specifically addressed herein, such as adaptations, variations, modifications, and equivalent arrangements, should be and are considered to be implicitly disclosed by the illustrative embodiments and claims described herein and therefore fall within the scope of the present invention.

Additionally, it is important to note that each term used herein refers to that which a person skilled in the relevant art would understand such term to mean based on the contextual use of such term herein. To the extent that the meaning of a term used herein, as understood by the person skilled in the relevant art based on the contextual use of such term, differs in any way from any particular dictionary definition of such term, it is intended that the meaning of the term as understood by the person skilled in the relevant art should prevail.

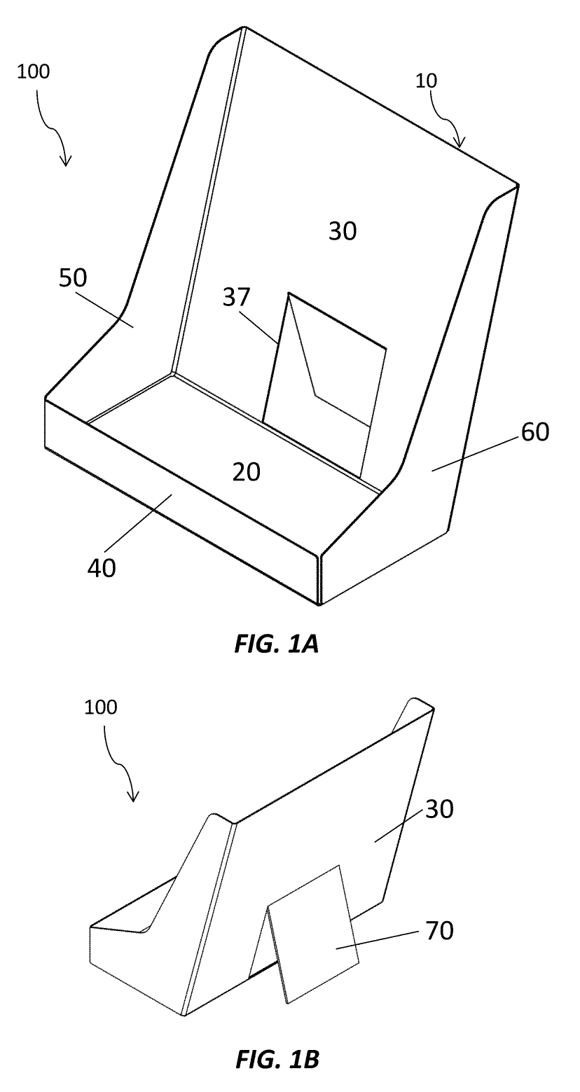

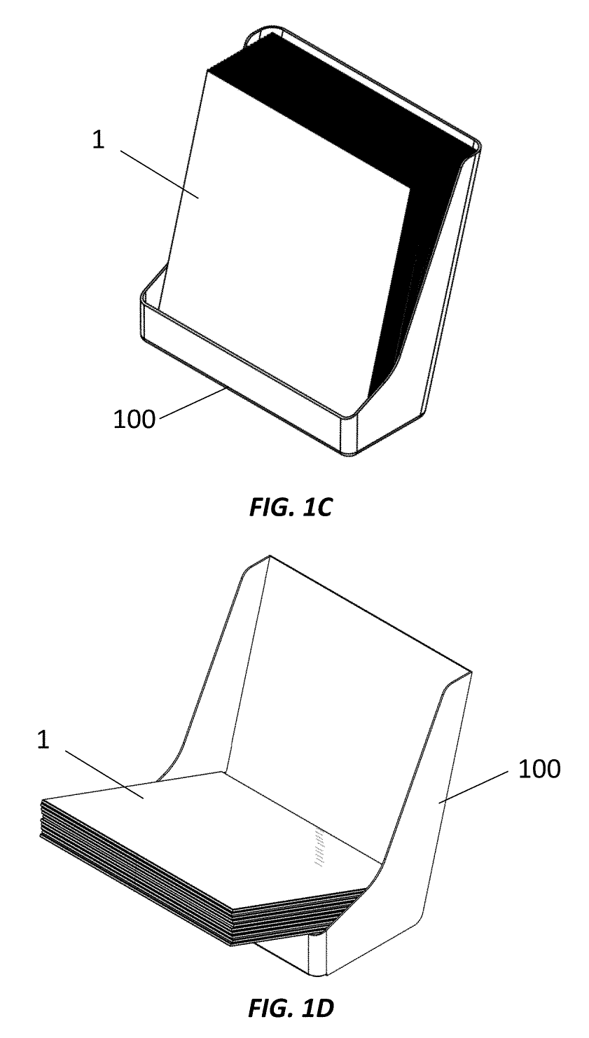

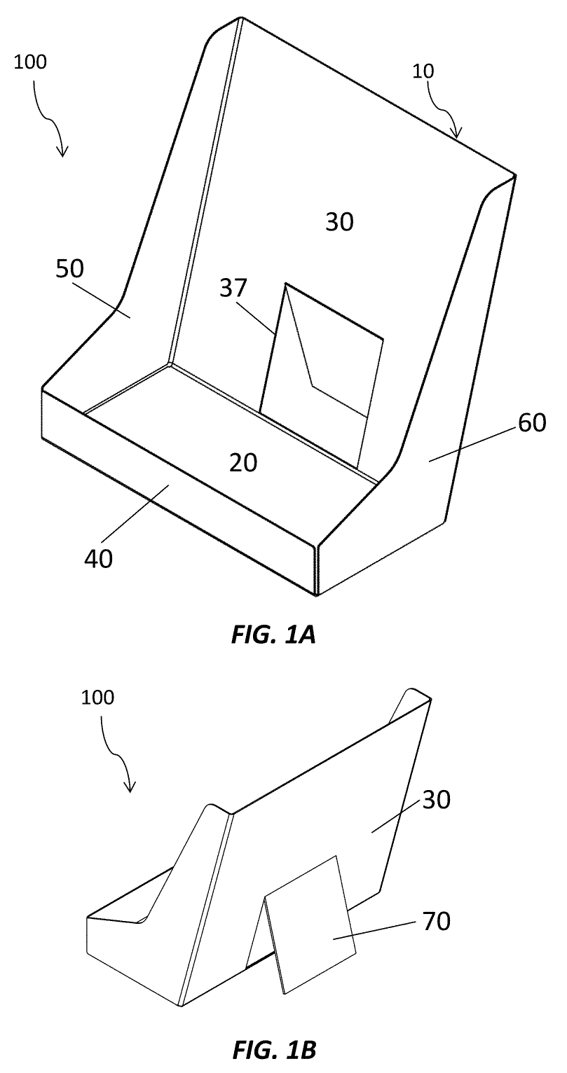

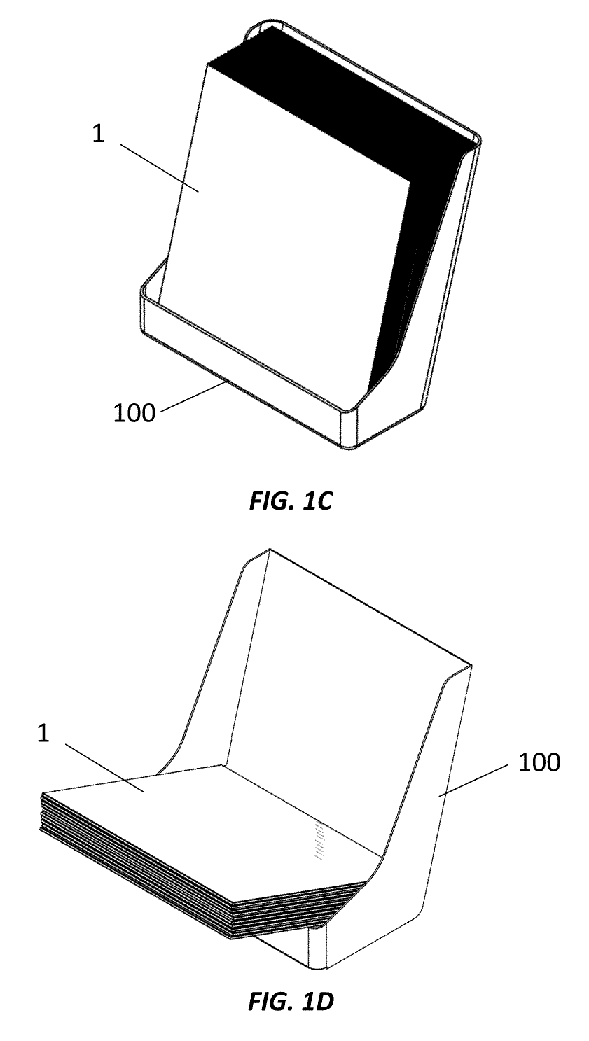

FIGS. 1A through 1D illustrate a display holder 100 (i.e., display stand, display bin, etc.) in accordance with a first embodiment of the present invention. FIG. 1A illustrates a forward perspective view of the holder 100. The holder 100 includes a main section 10 that provides a base 20, a back panel 30, and a front panel 40. The base 20 of the holder 100 can be placed on a flat surface, such as a table, shelf, etc. In some embodiments, the back panel 30 includes an opening 37. The holder 100 further includes a first side panel 50 and a second side panel 60. The main section 10, the first side panel 50, and the second side panel 60 define a recess for receiving display content.

FIG. 1B illustrates a reverse perspective view of the holder 100. In this embodiment, a kickstand 70 is attached to the back panel 30. The kickstand 70 is configured to support the holder 100. In FIG. 1B, the kickstand 70 is formed from and contiguous with the opening 37 (shown in FIG. 1A) of the back panel 30.

The holder 100 can be formed from a variety of suitable materials including, but not limited to, plastic, metal, and wood, and a combination thereof. For example, the material(s) could be, but are not limited to polyethylene, polyurethane, aluminum, brass, steel, iron, iron alloys, plywood, walnut, oak, cedar, corrugated cardboard, corrugated plastic, wire mesh, or even metal grill. It may be understood that the term “material” is used herein to indicate any substantially two-dimensional material suitable for incorporation into a holder, stand, or bin, including other rigid materials.

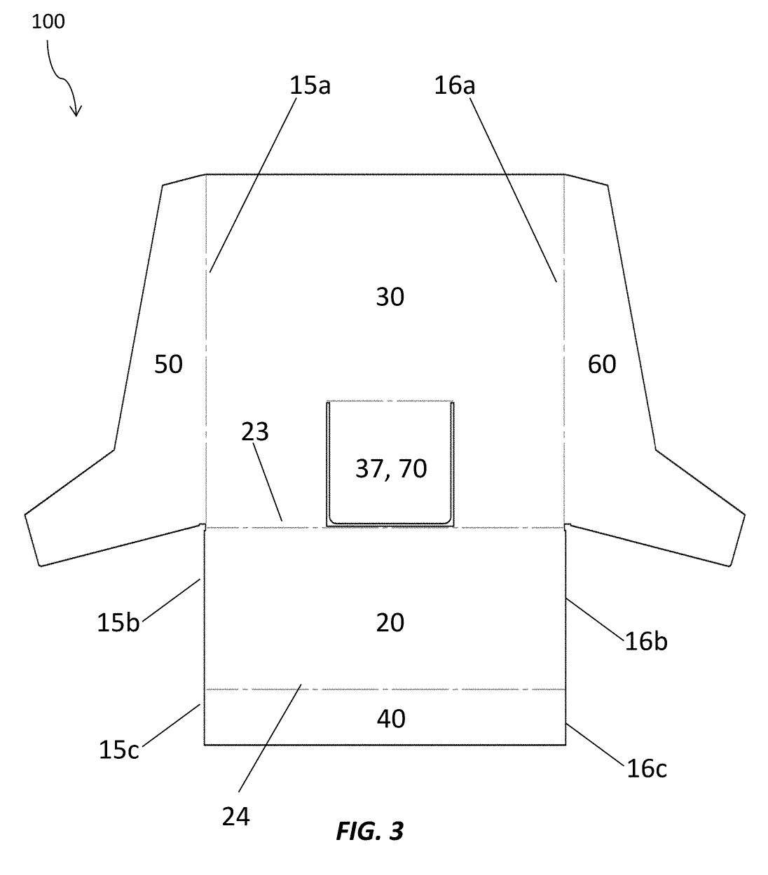

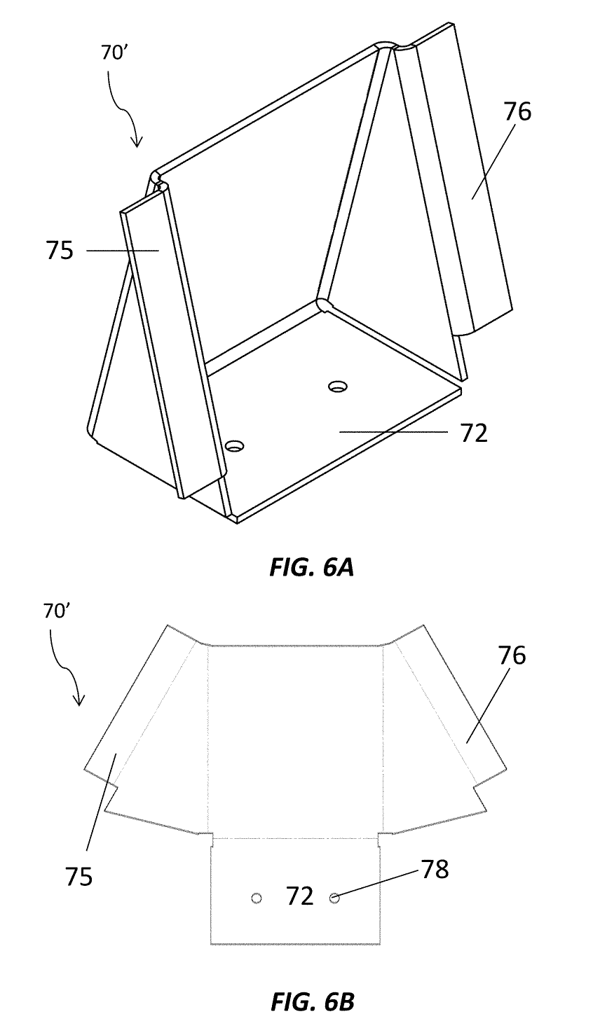

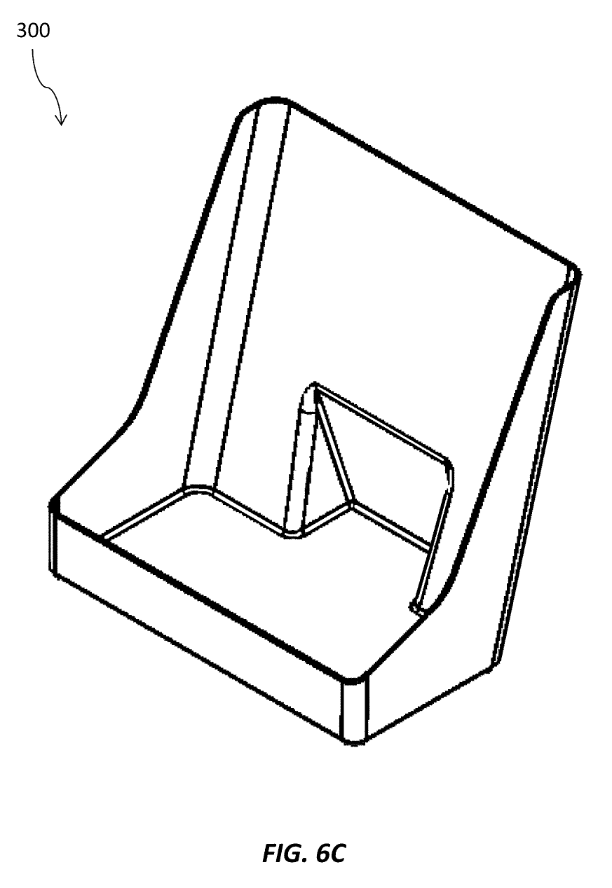

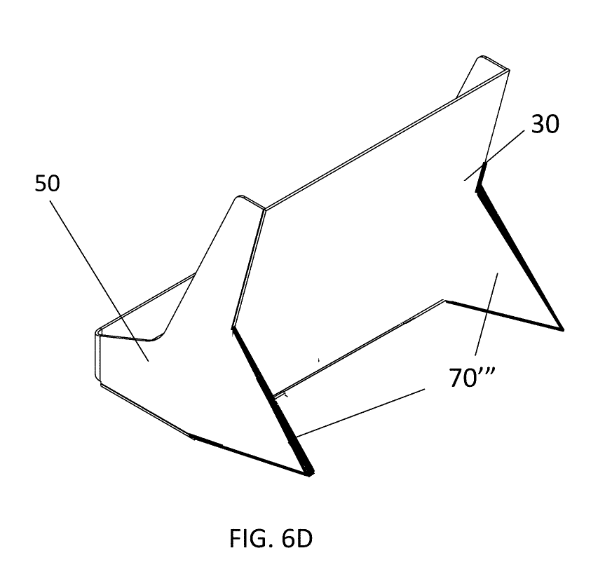

The holder 100 can be formed using a variety of suitable manufacturing methods including, but not limited to, molding, folding, and extruding. In an exemplary embodiment, the holder 100 is made from plastic that is melted and molded (e.g., poured into a form and cooled) into appropriate dimensions and shape. In another exemplary embodiment, the holder 100 is made from a sheet of plastic that is cut and folded into the appropriate dimensions and shape (see descriptions of FIGS. 3 and 6C for further detail). In yet another embodiment, the main section is extruded from plastic and the side panels 50, 60 are cut from sheet plastic; the side panels 50, 60 are attached (e.g., by melting, using an adhesive, etc.) to the main section 10.

In an exemplary embodiment, the holder 100 is made from metal that is melted and extruded until the appropriate dimensions and shape. In another exemplary embodiment, the holder 100 is made from a sheet of metal that is cut and folded into the appropriate dimensions and shape. In yet another embodiment, the main section is extruded from metal and the side panels 50, 60 are cut from sheet metal; the side panels 50, 60 are attached by means known in the art, including but not limited to, by welding, using an adhesive, using at least one screw and/or nail, to the main section 10. It may be understood that the holder 100 can be manufactured using one or more of the disclosed manufacturing methods or any suitable manufacturing method for rigid materials.

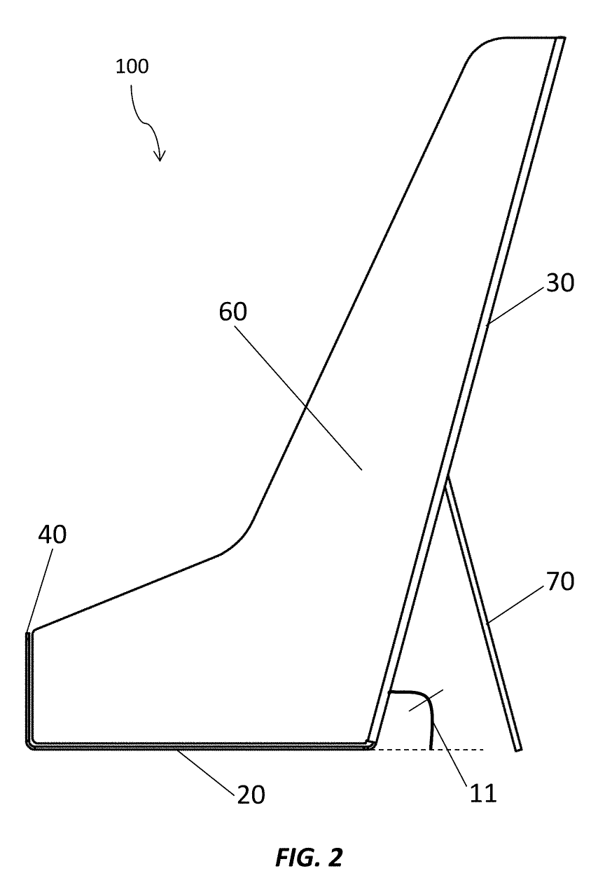

In general, FIG. 1C illustrates the holder 100 used to receive or support display content 1. The display content 1 can be, for example, a vinyl record in a screen cover including, for example but not limited to, 7 inch records and/or 12 inch records, a compact disc in a plastic case, a comic book, a collectible card, a brochure, a magazine, and the like. The recess defined by the main section 10 and the side panels 50, 60 receives at least one of the display content 1. In some embodiments, the holder 100 is configured to receive approximately 35 vinyl records. As shown in FIG. 1C, the display content 1 is, in a first position, primarily supported by the back panel 30 of the holder 100. The shape (see description of FIG. 2 for further detail) of the holder 100 is optimized so that the display content 1 can be easily viewed by a person standing in front of the holder 100 and looking down towards the display content 1.

Alternatively, FIG. 1D illustrates the display content 1 supported in a second position by the front panel 40 of the holder 100. A person standing in front of the holder 100 and looking down towards the display content 1 may change the position of at least one display content 1 to be supported by the front panel 40 so that the larger surface area allows other display content 1 to be more visible and viewable. Thus a plurality of display content 1 is easily accessible and browsing is facilitated.

FIG. 2 illustrates a side view of the holder 100. The second side panel 60 is generally L-shaped, but it is to be understood that other shapes are also contemplated and the side panel 50, 60 shape is not intended to be limited to a generally L-shape. Additionally, various features (e.g., rounding, edging, etc.) can be added to a general shape of the side panels 50, 60. The back panel 30 protrudes from the base 20 (not shown) at an angle 11 between 45 degrees and approximately 80 degrees from a horizontal plane defined by the base 20. For example, in one embodiment, the angle is about 77 degrees (i.e., 13 degrees from vertical). Making the angle 11 between 45 degrees and approximately 80 degrees enables a person to see a face of the display content 1 (not shown) and reduces the amount of space required to store the display content 1. The front panel 40 protrudes from the base 20 substantially orthogonally (i.e., perpendicularly) from the horizontal plane defined by the base 20. The front panel 40 keeps the display content 1 within the recess defined by the main section 10 and the side panels 50, 60. In order to provide the person with a view of the face of the display content 1, the front panel 40 is substantially shorter than the back panel 30. In some embodiments, the front panel 40 is 67% shorter than the back panel 30.

For example, in an embodiment of the holder 100 for displaying vinyl records in screen covers (i.e., the display content 1), the first side panel 50 is spaced approximately 13 inches (i.e., 12.75 inches) from the second side panel 60; the back panel 30 extends between the side panels 50, 60. The screen covers of vinyl records are slightly smaller than 13 inches and the holder 100 snuggly yet accessibly accommodates the screen covers. The back panel 30 is between 9 and 12 inches (e.g., 10.88 inches) tall (i.e., measured from the base to a distal end of the back panel 30) to support the display content 1. The front panel 40 is less than about 3.59 inches (i.e., 67% shorter than the back panel 30; e.g., 2.00 inches) tall. The base 20, extending between the back panel 30 and the front panel 40, is about 6 inches (i.e., 5.64 inches) long to support a plurality of display content 1.

The dimensions of the holder 100 can be changed to accommodate other display content 1. In some embodiments, the display holder dimensions are configured to receive 7 inch vinyl records and/or 12 inch vinyl records. For example, the dimensions of the holder 100 would be smaller to receive a compact disc, a collectible card, or a comic book in the recess defined by the main section 10 and the side panels 50, 60.

FIG. 3 illustrates an assembly view of the holder 100. The base 20 has a back edge 23 and a front edge 24. The back panel 30 protrudes from the back edge 23 of the base 20 and the front panel 40 protrudes from the front edge 24 of the base 20. The first side panel 50 protrudes from a first edge 15a of the back panel 30. In other embodiments, the first side panel 50 may protrude from a first edge 15b of the base 20 or from a first edge 15c of the front panel 40. Similarly, the second side panel 60 protrudes from a second edge 16a of the back panel 30. In other embodiments, the second side panel 60 may protrude from a second edge 16b of the base 20 or from a second edge 16c of the front panel 40.

For subsequent disclosure, the first edge 15a-15c and the second edge 16a-16c have been referred to in their complete/assembled form. In its assembled form, the holder 100 may be understood to have a first edge 15 (previously being the first edge 15a, 15b, and 15c) and a second edge 16 (previously being the second edge 16a, 16b, 16c). As illustrated, the first edge 15 and the second 16 are at opposite ends of the main section. When constructed, the first side panel 50 and the second side panel 60 are completely attached to the first edge 15 and the second edge 16, respectively (as illustrated in FIGS. 1A through 1C).

As previously discussed with respect to FIG. 1B, the holder 100 can be manufactured from a variety of materials (e.g., plastic, metal, wood, and a combination thereof, etc.) using a variety of manufacturing methods. The following exemplary embodiment uses folding to assemble material previously cut. During assembly, the main section 10 (i.e., the base 20, the back panel 30, and the front panel 40) is formed by folding the material (e.g., plastic, metal, etc.) along the back edge 23 and the front edge 24 to create the shape illustrated in FIGS. 1A, 1B, and 2. The back panel 30 is folded towards the base 20 in a first direction, and the front panel 40 is folded towards the base 20 in a second direction, wherein the second direction is opposite the first direction. The angle 11 between the back panel 30 and the horizontal plane defined by the base 20 is created by folding along the back edge 23. In some embodiments, the holder 100 is composed of corrugated cardboard and/or plastic; a user purchases the holder 100 in an unassembled form (as depicted in FIG. 3). The user assembles (i.e., folds, forms, attaches, etc.) the holder 100 into the shape depicted in FIGS. 1A, 1B, and 2.

Referring to FIG. 3, the first side panel 50 protrudes from the first edge 15a of the back panel 30 and the second side panel 60 protrudes from the first edge 16a of the back panel 30. After folding (e.g., in a third and fourth direction, each orthogonal to the first direction, wherein the fourth direction is opposite the third direction), the side panels 50, 60 are substantially close to the remainder of the side edges 15b, 15c and 16b, 16c, respectively. The side panels 50, 60 can be attached to the portions of the side edges 15, 16 from which they do not protrude. In one embodiment, the side panels 50, 60 are attached to the side edges 15, 16 by melting the material near the side edges 15, 16. In another embodiment, the side panels 50, 60 are attached to the side edges 15, 16 by welding the material near the side edges 15, 16. In yet another embodiment, the side panels 50, 60 are attached to the side edges 15, 16 using adhesive on the material near the side edges 15, 16. After allowing time for the attachment to form (i.e., cool, set, settle), the holder 100 is ready for use with display content 1.

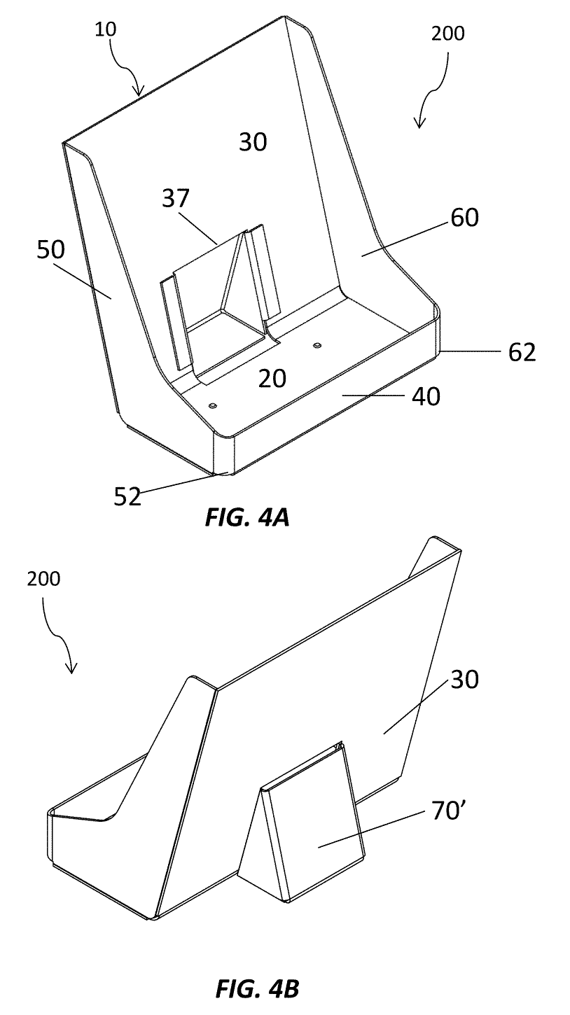

FIGS. 4A and 4B illustrate a display holder 200 (i.e., display stand, display bin, etc.) in accordance with a second embodiment of the present invention. FIG. 4A illustrates a forward perspective view of the holder 200. The holder 200 includes a main section 10 that provides a base 20, a back panel 30, and a front panel 40. The base 20 of the holder 200 can be placed on a flat surface, such as a table, shelf, etc. In some embodiments, the back panel 30 includes an opening 37. The holder 200 further includes a first side panel 50 and a second side panel 60. The main section 10, the first side panel 50, and the second side panel 60 define a recess for receiving display content 1.

In some embodiments, the holder 100 includes a first cut-out 52 and a second cut-out 62. The cut-outs 52, 62 are formed in the corners between the side panels 50, 60 and the main panel 10, respectively. The cut-outs 52, 62 are configured to receive a corner of the display content 1 (not shown), and provide better support. In some embodiments, more cut-outs 52, 62 are included (e.g., to receive and support the display content 1 in the second position depicted in FIG. 1D).

FIG. 4B illustrates a reverse perspective view of the holder 200. In some embodiments, a kickstand 70′ is attached (e.g., removable and/or permanently) to the back panel 30. The kickstand 70′ is positioned to support the holder 200. In FIG. 4B, the kickstand 70′ is formed from a piece of material separate from the holder 200. In some embodiments, no kickstand 70′ is provided, for example, if the holder 200 is wall-mounted.

As previously disclosed with respect to FIG. 1B, the holder 200 can be formed from a variety of suitable materials including, but not limited to, corrugated (e.g., cardboard and/or plastic), plastic (e.g., polyethylene), metal (e.g., aluminum), and wood (e.g., plywood), and a combination thereof. Additionally, the holder 200 can be formed using a variety of suitable manufacturing methods including, but not limited to, molding, folding, and extruding.

As previously disclosed with respect to FIG. 2, the side panels 50, 60 are generally L-shaped. The back panel 30 protrudes from the base 20 at an angle 11 between 45 degrees and approximately 70 degrees from a horizontal plane defined by the base 20. The front panel 40 protrudes the base 20 at a substantially orthogonal (i.e., perpendicular) from the horizontal plane defined by the base 20. The front panel 40 is substantially shorter than the back panel 30. In some embodiments, the front panel 40 is 67% shorter than the back panel 30.

Referring to FIGS. 4A and 4B, in an embodiment of the holder 200 for displaying vinyl records in screen covers or the display content 1, the holder 200 is provided with panels spaced at distances adapted to support the display content 1. For example, in the embodiments of FIGS. 4A and 4B, the first side panel 50 is spaced approximately 13 inches (i.e., 12.75 inches) from the second side panel 60; the back panel 30 extends between the side panels 50, 60. The back panel 30 is between 9 and 12 inches (e.g., 10.88 inches) tall, measurements taken from the base to a distal end of the back panel 30, to support the display content 1. The front panel 40 is less than about 3.59 inches (i.e., 67% shorter than the back panel 30; e.g., 2.00 inches) tall. The base 20, extending between the back panel 30 and the front panel 40, is about 6 inches (i.e., 5.64 inches) long to support a plurality of display content 1.

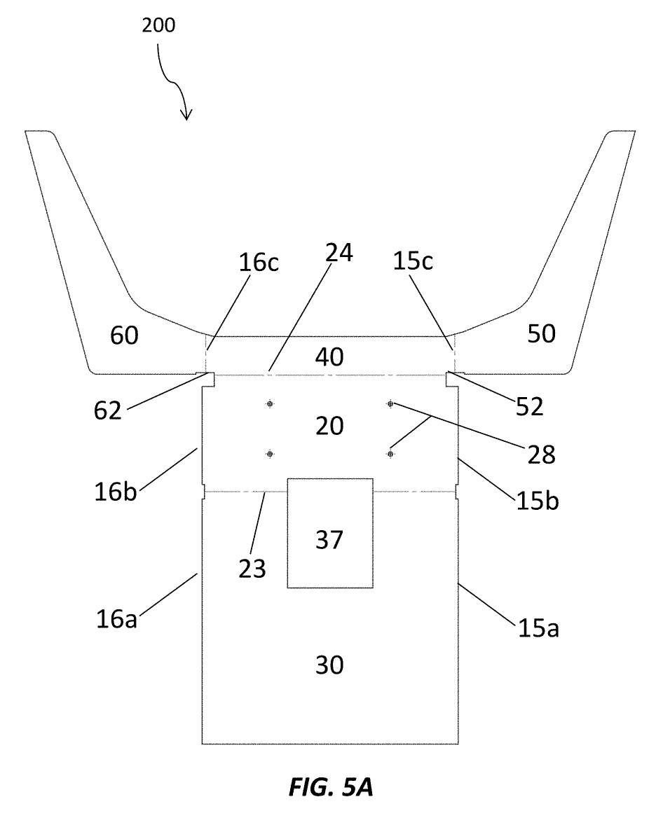

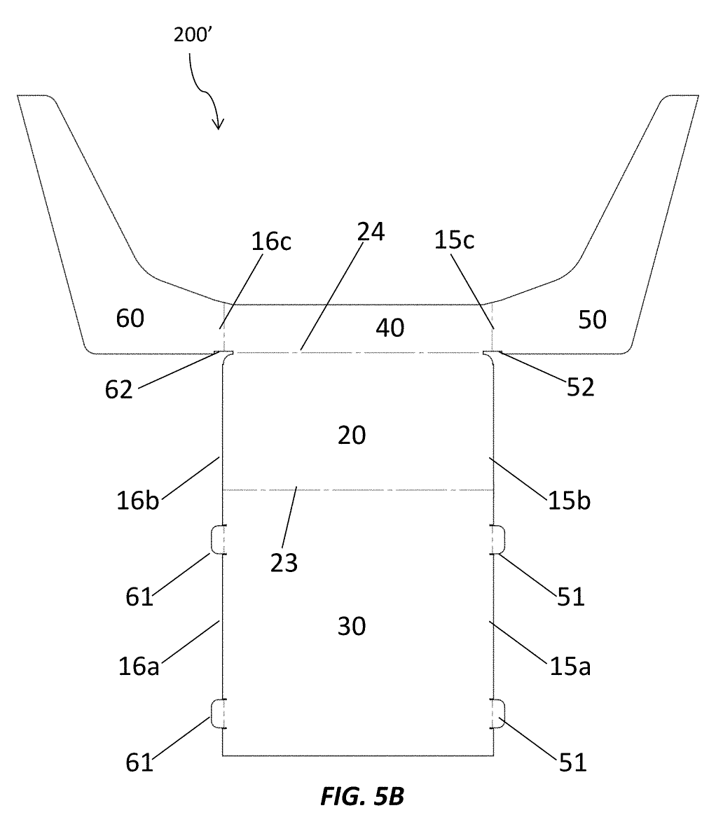

FIG. 5A illustrates an assembly view of the holder 200. The base 20 has a back edge 23 and a front edge 24. The back panel 30 protrudes from the back edge 23 of the base 20 and the front panel 40 protrudes from the front edge 24 of the base 20. The first side panel 50 protrudes from a first edge 15c of the front panel 40. In other embodiments, the first side panel 50 may protrude from a first edge 15a of the back panel 30 or from a first edge 15b of the base 20. Similarly, the second side panel 60 protrudes from a second edge 16c of the front panel 40. In other embodiments, the second side panel 60 may protrude from a second edge 16a of the back panel 30 or from a second edge 16b of the base 20. The holder 200 can include the first cut-outs 52 and the second cut-outs 62 between the base 20, the front panel 40, and/or the side panels 50, 60.

In some embodiments, the holder 200 further includes at least one rubber pad 28. The at least one rubber pad is operable to grip the surface on which the holder 200 is placed. In other embodiments, the holder 200 includes feet (not shown) that are removably attached to the base 20. The at least one rubber pad (or the feet) can be composed of a variety of material(s) including, but not limited to, wool, cotton, metal, rubber, plastic, etc.

The following exemplary embodiment uses folding to assemble material previously cut. During assembly, the main section 10 (i.e., the base 20, the back panel 30, and the front panel 40) is formed by folding the material (e.g., plastic, metal, etc.) along the back edge 23 and the front edge 24 to create the shape illustrated in FIGS. 4A and 4B. The back panel 30 is folded towards the base 20 in a first direction, and the front panel 40 is folded towards the base 20 in a second direction, wherein the second direction is opposite the first direction. The angle 11 between the back panel 30 and the horizontal plane defined by the base 20 is created by folding along the back edge 23.

Referring to FIG. 5A, the first side panel 50 protrudes from the first edge 15c of the front panel 40 and the second side panel 60 protrudes from the first edge 16c of the front panel 40. After folding, the side panels 50, 60 are substantially close to the remainder of the side edges 15a, 15b and 16a, 16b, respectively. The side panels 50, 60 can be attached to the portions of the side edges 15, 16 from which they do not protrude.

As previously disclosed, the side panels 50, 60 are attached to the side edges 15, 16 by melting, by welding, or by using adhesive on the material near the side edges 15, 16.

FIG. 5B illustrates an assembly view of a holder 200′. The holder 200′ is similar to the holder 200 depicted in FIG. 5A. Additional features include, but are not limited to, at least one first tab 51 and at least one second tab 61. The at least one first tab 51 is operable to attach (e.g., using adhesive) the back panel 30 to the first side panel 50, and the at least one second tab 61 is operable to attach the back panel to the second side panel 60. A person skilled in the art would understand that the placement of the tabs 51, 61 can be adjusted along the first edge and the second edge of the holder 200′. The cutouts 52, 62 of FIG. 5B are also a different shape than the cutouts 52, 62 of FIG. 5A.

FIGS. 6A through 6B illustrate the kickstand 70′ of the holder 200. FIG. 6A illustrates a forward perspective view of the kickstand 70′. A base 72 of the kickstand 70′ can be placed on a flat surface, such as a table, shelf, etc. A first side overlap 75 and a second side overlap 76 can be inserted into the opening 37 of the holder 200. The overlaps 75, 76 are then attached to the holder 200 using any of the attachment methods previously disclosed.

FIG. 6B illustrates an assembly view of the kickstand 70′. The kickstand 70′ is assembled in a similar order and method as the holder 200 illustrated in FIGS. 4A and 4B. In some embodiments, the kickstand 70′ includes at least one rubber pad 78 for gripping the surface on which the base 72 is placed.

FIG. 6C illustrates a perspective view of a holder 300, according to a third embodiment of the present invention. In this embodiment, a kickstand is formed as part of the panels. For example, the holder 300 is manufactured by molding plastic. The kickstand (e.g., similar to kickstand 70′ of FIGS. 6A and 6B) is not removable.

FIG. 6D also illustrates a perspective view of a kickstand 70′″according to the invention wherein the kickstand 70″′ is formed as a part of the panels, in this embodiment, the side panels 50, 60. To provide support and stability to the holders, the kickstand 70″′ extends from the side panels 50, 60 in the direction of the back panel 30, and extends until stability is provided to the configuration and angled back panel 30 so that the angle of the back panel 30 from the base 20 is inconsequential. The kickstand 70′″ can be created from the same material of the side panels 50, 60 and extend therefrom , or in another embodiment, the kickstand 70′″ can be contiguous with and adjacent the side panels 50, 60. The kickstand can be the same or a different material as the side panels 50, 60.

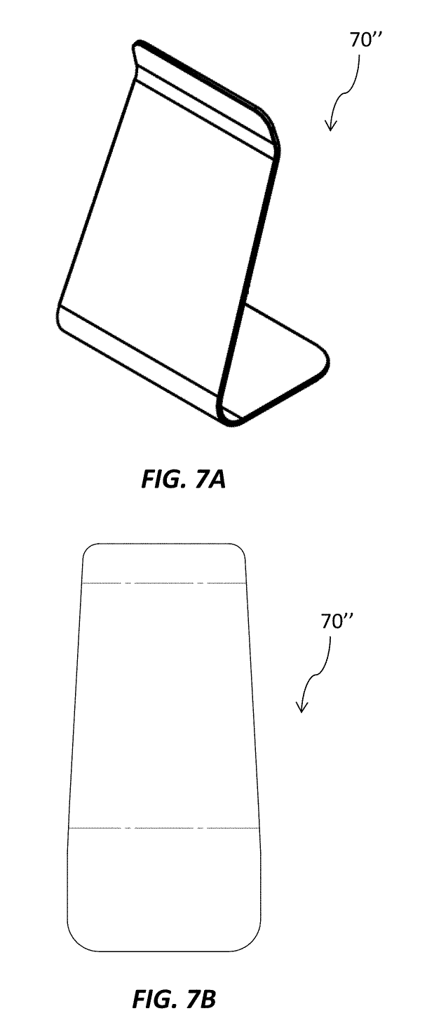

FIG. 7A illustrates a perspective view of a kickstand 70″. The kickstand 70″ can be used with holders 100 or 200, and attached to holders 100 or 200 using the attachment methods previously disclosed. In some embodiments, the kickstand 70″ is removable attached (e.g., using a magnetic material and/or components, using an adhesive, etc.) In other embodiments, the kickstand 70″ is welded to the holders 100, 200. In another embodiment (not illustrated), the kickstand 70, 70′, 70″ may be replaced by a wall mount for the holders 100 or 200.

FIG. 7B illustrates an assembly view of the kickstand 70″. The kickstand 70″ is assembled in a similar order and method as the kickstand illustrated in FIGS. 6A and 6B. In some embodiments, the kickstand 70″ includes at least one rubber pad 78 (not shown) for gripping the surface on which the base 72 is placed.

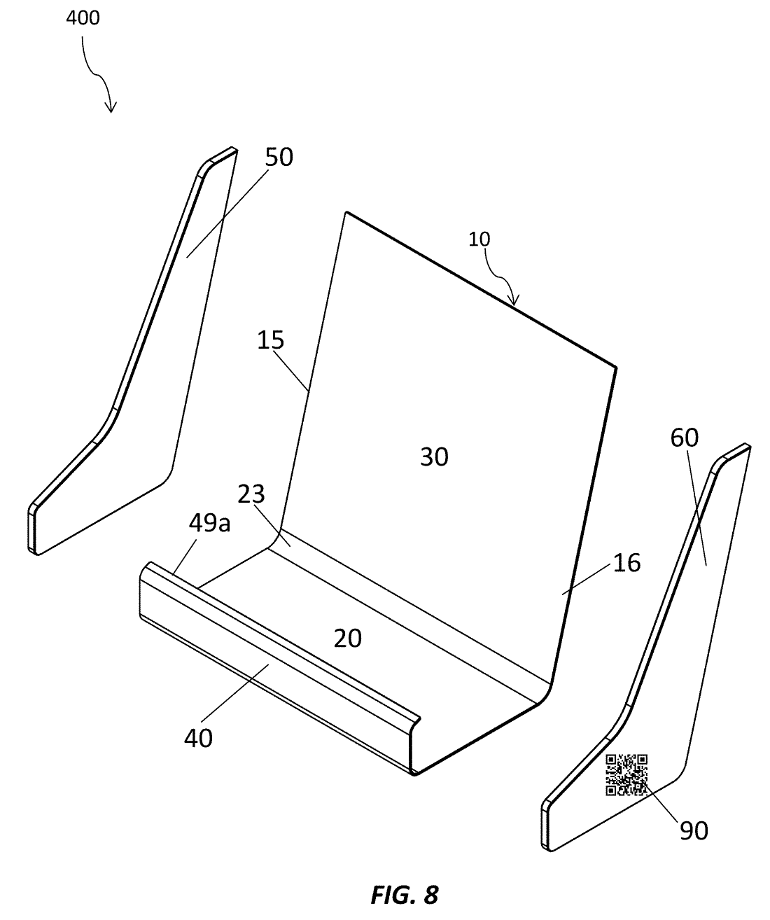

FIG. 8 illustrates an exploded view of a display holder 400 (i.e., display stand, display bin, etc.) in accordance with a fourth embodiment of the present invention. The main section 10 (comprised of the base 20, the back panel, and the front panel 40) is composed of a first material (e.g., plastic) and the side panels 50, 60 is composed of a second material (e.g., metal). The base 20 may include a rounded edge 23 (i.e., back edge 23). The front panel 40 may include a lower lip 49a (i.e., fold) and an upper lip 49b. In some embodiments, the side panel 60 includes a QR code 90. The QR code 90 can be read by a cellular device (not shown), opening an application (e.g., a web browser) that displays an image of the display content 1 (e.g., album cover art). The user of the holder 400 can add data to the application opened via the QR code to reflect the display content 1 currently received by the holder 400.

Referring to FIG. 8, in one embodiment, the first side panel 50 and the second side panel 60 of the holder 400 are manufactured by cutting a material (e.g., plastic, metal, etc.). The side panels 50, 60 are attached to the main section 10, using any of the attachment methods previously disclosed, along the side edges 15, 16, respectively. In some embodiments, the side panels 50, 60 are composed of a material different than the main panel 10.

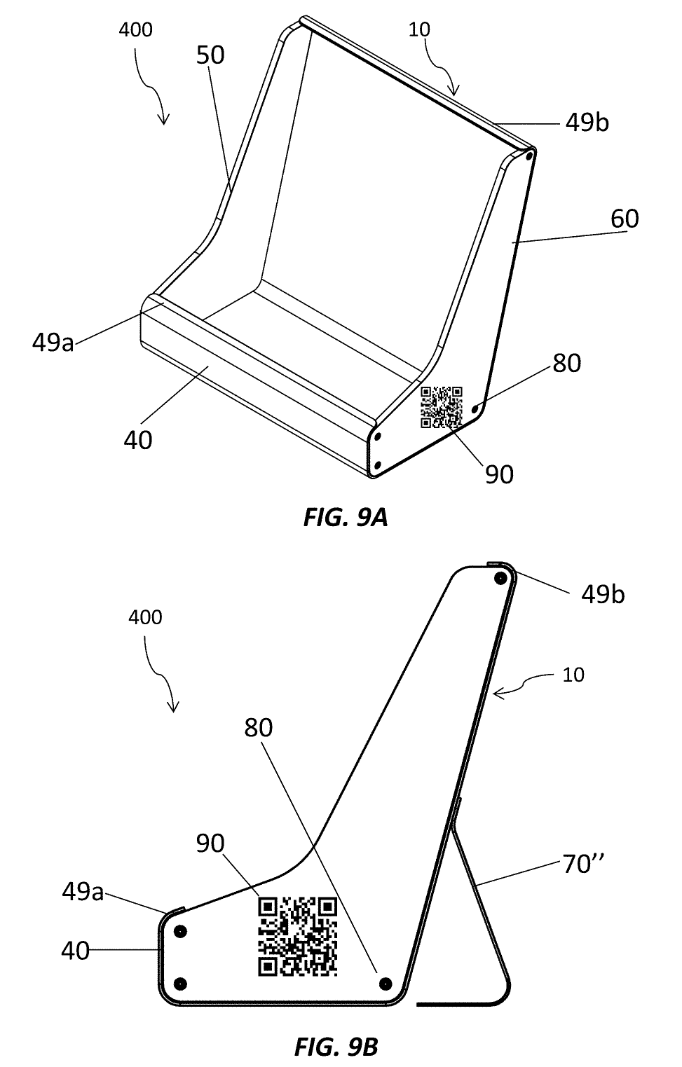

FIGS. 9A and 9B illustrate a perspective view and a side view, respectively, of the holder 400. In some embodiments, the side panels 50, 60 include holes 80. The holes 80 are operable to receive a screw and/or nail to attach the side panels 50, 60 to the main panel 10. The kickstand 70″ can be removably or permanently attached to the holder, as previously described with respect to FIGS. 7A and 7B.

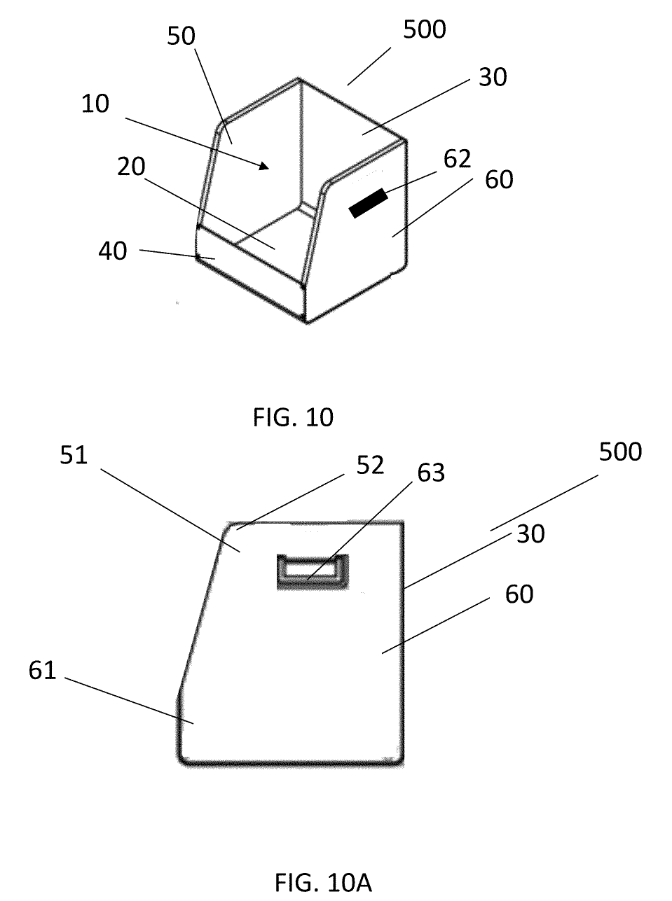

FIG. 10 illustrates yet another holder 500. In this embodiment of the holder 500, the side panels 50, 60, and the back panel 30 define a deeper main section 10 that can receive a plurality of display content 1. The depth of the main section 10 is concluded at the front panel 40. The front panel 40 protrudes from the base 20 substantially orthogonally (i.e., perpendicularly) from the horizontal plane defined by the base 20. The front panel 40 keeps the display content 1 within the recess defined by the main section 10 and the side panels 50, 60. The front panel 40 is substantially shorter than the back panel 30 in this embodiment as well.

As previously mentioned, the side panels 50, 60 are generally L-shaped, but it is to be understood that other shapes are also contemplated and the side panel 50, 60 shape is not intended to be limited to a generally L-shape. In this embodiment illustrated in FIG. 10, the side panels are trapezoidal in shape in the upper portion 51, and contiguous with a rectangular shape on the lower portion 61, with, in this embodiment, rounded corners at the top corner 52. In this embodiment, the back panel 30 protrudes from the base at an angle of approximately ninety degrees. As previously mentioned when discussing FIG. 2, the further from vertical angles created where the back panel 30 protrudes from the base allows for a shorter base 20 for the display content 1. In this embodiment, the substantially vertical angle allows for a longer base 20, for instance, but not limited to between 15 inches and 10 inches, preferably between about 13 inches and 11 inches, and more preferably about 12 inches, and is more useful for storage than display, but can also allow for display when the display content 1 is held upright either via volume, balance, via notches having for instance a female receiving portion, (not shown) along the base 20 configured to receive individual or a plurality of display content 1. A more vertical back panel 30 allows flipping through the display content 1 with front visibility less angled. In this particular embodiment, a plurality of display content 1 can be a larger number, and therefore, the side panels 50, 60 can be provided with handle apertures 63 (see FIG. 10A), or identification parts 62 for identifying display content 1 currently received in the holder 500. The identification part 62, can be, for instance, but not limited to a QR code 90, an erasable surface including a chalk board surface, a surface for writing, and a surface which can receive a sticker or a hook and loop fixture. These embodiments of the identification parts 62 are not meant to be limiting and a person of skill in the art would understand that there are other means for identification that can easily be accommodated by this part 62.

As with other embodiments, the materials can be any material which can support the shape of the holder and with display content resting therein.

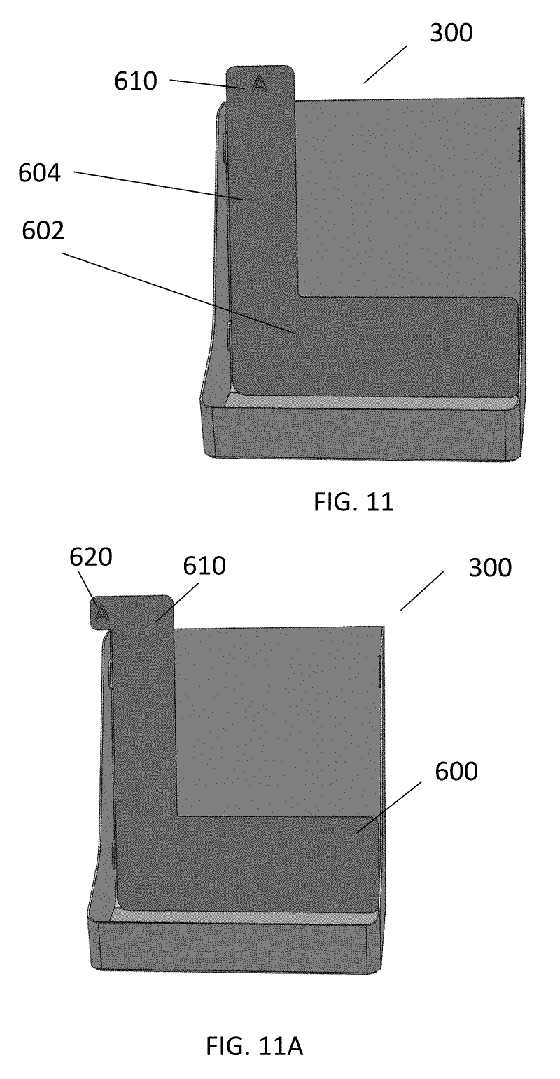

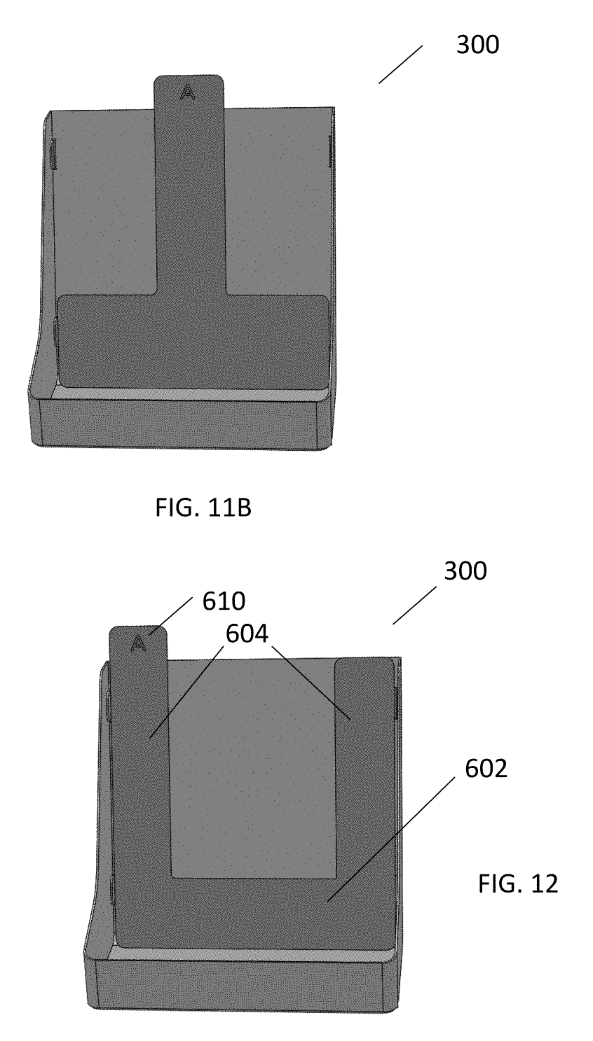

FIG. 11 illustrates a divider 600 which can be used with a display holder 100, 200, 300, 400, 500. The divider 600 can be used to separate at least two display content 1 in a holder, defining two divided sections on either side of a divider 600. The divider 600 can be made of any material understood in the art to retain its shape, be rigid, and without wilting for instance, and without limitation, plastic, wood, metal, or a combination of materials, among other materials. The divider 600 in an embodiment can also be configured with a first tab 610 for easily locating the divider 600 and manipulating the divider 600, backwards and forward such that any display content 1 can be seamlessly flipped from the front to the back, display content 1 in a particular divided section can be located and viewed, while still remaining in the divided section defined by the divider 600. The divider 600 in another embodiment can be provided with a second tab 620 on the first tab 610 (see e.g. FIG. 11A), contiguous or immediately adjacent to. The first and/or the second tab 610, 620 can be provided with identifying information such as a section number and/or a QR code for providing identifying information about display content 1 in a particular divided section defined by the divider 600.

The divider 600 can be provided with different configurations. A divider 600 has a divider base 602 which extends substantially the width of the main section 10 of a display holder and an arm 604 which extend from the divider base 602. The divider base 602 of the divider 600 is flat along the entire length of the divider 602, the depth and height can be any depth and height that facilitate the desired shape and manipulation of the display content. The base 602 can have any depth and height as well, for instance a depth of between about 0.5 inches to about 3.5 inches. The arm 604 and the divider base 602 are contiguous such that manipulation of the arm 604 also manipulates the divider base 602. In an embodiment the arm 604 and the divider base 602 are made of a single material as a single unit, in another embodiment each is made of different materials, and in yet another embodiment the arm 604 and the divider base 602 is made of at least two materials each, with at least one material in common. The location of the arm 604 on the divider base 602 in an embodiment can be anywhere along the length of the divider base 602 and extending upwardly. In an embodiment whereby the tab 610, 620 does not have identifying features, it can be said that the arm 604 can be located closer to the end of the length of the divider base 602, or closer to the center of the divider base 602, and flipped in either direction for use in a display holder. An advantage of such a simple configuration is that such an arm 604 or a plurality of arms 604 without identifying information on a tab 610, 620 can be inserted into a display holder on the left or the right to accommodate a left handed or a right handed user.

For embodiments having tabs 610, 620 with identifying information thereon, left and right embodiments of the divider 600 are also provided and the orientation of the arm 604 on the divider base 602 is determined according to the face of the tab 610, 620 whereby a user can see identifying information thereon. In an embodiment of the divider 600, the arm 604 can be to the right of center along the length of the divider base 602 (not shown), in another embodiment it is to the left of center of the divider base 602 (see e.g. FIG. 11), in yet another embodiment, the arm 604 is in substantially the center of the divider base 602 (see e.g. FIG. 11B). In an embodiment, the arm 604 can project substantially vertically from the divider base 602. In yet another embodiment, the arm 604 can project at an upward diagonal angle from one side of the length of the divider base 602 upwards towards the other side top corner and terminating at the other side of the length of the divider base 602.

In yet another embodiment illustrated in FIG. 12, the divider 600 has a plurality of arms 604 extending upwards from a single divider base 602. The divider 600 has an advantage that when manipulated forwards and backwards, the display content 1 is also manipulated in the same direction. A single display holder can accommodate one or a plurality of dividers 600.

As to the manner of usage and operation of the present invention, the same should be apparent from the above description. Accordingly, no further discussion relating to the manner of usage and operation will be provided.

While an embodiment of the holder has been described in detail, it should be apparent that modifications and variations thereto are possible, all of which fall within the true spirit and scope of the invention. With respect to the above description then, it is to be realized that the optimum dimensional relationships for the parts of the invention, to include variations in size, materials, shape, form, function and manner of operation, assembly and use, are deemed readily apparent to one skilled in the art, and all equivalent relationships to those illustrated in the drawings and described in the specification are intended to be encompassed by the present invention.

Throughout this specification, unless the context requires otherwise, the word “comprise” or variations such as “comprises” or “comprising” or the term “includes” or variations, thereof, or the term “having” or variations thereof will be understood to imply the inclusion of a stated element or integer or group of elements or integers but not the exclusion of any other element or integer or group of elements or integers. In this regard, in construing the claim scope, an embodiment where one or more features is added to any of the claims is to be regarded as within the scope of the invention given that the essential features of the invention as claimed are included in such an embodiment.

Those skilled in the art will appreciate that the invention described herein is susceptible to variations and modifications other than those specifically described, and that each embodiment is also provided with features that may be applicable to other embodiments. It is to be understood that the invention includes all such variations and modifications that fall within its spirit and scope. The invention also includes all of the steps, features, compositions and compounds referred to or indicated in this specification, individually or collectively, and any and all combinations of any two or more of said steps or features.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

We claim:

1. A divider for display holder, the divider comprising:
a base; and
a plurality of arms.

2. A holder for display content, the holder comprising:
a main section including a base, a back panel, and a front panel, wherein the back panel protrudes from a back edge of the base at, and the front panel protrudes from a front edge of the base;
a first side panel attached to a first edge of the main section;
a second side panel attached to a second edge of the main section, wherein the main section, the first side panel, and the second side panel define a recess for receiving the display content; and
a plurality of dividers.

3. The divider of claim 1 further comprising a first tab.

4. The divider of claim 3 further comprising a second tab.

5. The divider of claim 1 having a single arm located off of the center of the base.

6. The divider of claim 1 having two arms substantially vertical from the base and each located off of the center of the base.

7. The divider of claim 1 having a single arm substantially vertical to and centered along a length of the base.

8. The divider of claim 3 wherein the first tab has a face with at least one identifying part located on the face.

9. The divider of claim 4 wherein a least one the first and the second tab have a face with at least one identifying part located thereon.

10. The divider of claim 1 wherein the divider is composed of at least one of the materials from the group consisting of plastic, wood, metal, a mixture, a composite, glass, ceramic, corrugated cardboard, and paper.

11. The divider of claim 8 wherein the identifying part is a QR code.

12. The divider of claim 9 wherein the identifying feature is at least one selected from the group consisting of a QR code, an erasable chalk board, a sticker, a digital display, and an erasable board.

13. The divider of claim 4 wherein at least one of the first and second tab is located vertically on a top of the arm, wherein the top of the arm is opposing the base.

14. The divider of claim 4 wherein at least one of the first and second tab is located adjacent to and contiguous with a top of the arm, wherein the top of the arm is opposing the base.

15. The divider of claim 1 wherein at least one of the plurality of arms has a first and a second end, wherein the arm base continuous with the base at the first end, and an arm top at the second end contiguous with the arm, and wherein the arm is configured to diagonally extend from the a first position on the length of the arm base at the first end to the second end so that the top of the arm is located at a different position perpendicularly above the length of the base away from a position of the arm base along the length of the base.

16. The divider of claim 15 wherein at least two of the plurality of arms are disposed at a diagonal along the length of the base on opposing sides along the length of the base at the arm base, crossing and disposed at the top of the arm opposing the other at different locations perpendicular to the length of the arm.
